(19) United States
(12) Patent Application Publication
(10) Pub. No.: US 2009/0071953 A1
(43) Pub. Date: Mar. 19, 2009

(54) INDUCTION HEATING ELEMENT MADE OF GLASSY CARBON, HEATING DEVICE AND HEATER

(75) Inventor: Maki Hamaguchi, Hyogo (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA KOBE SEIKO SHO (Kobe Steel, Ltd), Kobe-shi (JP)

(21) Appl. No.: 11/911,126

(22) PCT Filed: Mar. 31, 2006
(86) PCT No.: PCT/JP2006/306820

§ 371 Date: Oct. 10, 2007

(30) Foreign Application Priority Data
Apr. 13, 2005 (JP) 2005-115902

(51) Int. Cl. H05B 6/02

(52) U.S. Cl. 219/600

(57) ABSTRACT

A glass-like carbon induction heating element having high heating efficiency and a heating apparatus are provided. A glass-like carbon induction heating element, which inductively generates heat by electromagnetic induction, has an infrared radiation characteristic that a ratio (E1/E2) of infrared radiation intensity (E1) of an opposed face to an object-to-be-heated to infrared radiation intensity (E2) of a non-opposed face to the object-to-be-heated exceeds 1.2. A heating apparatus has the glass-like carbon induction heating element, and a high frequency induction coil that is disposed outside the glass-like carbon induction heating element for allowing the glass-like carbon induction heating element to inductively generate heat, wherein the high frequency induction coil is applied with a current so that the object-to-be-heated is heated by infrared rays radiated from the glass-like carbon induction heating element.

### TECHNICAL FIELD

The present invention relates to a glass-like carbon induction heating element used as a heating element that inductively generates heat by electromagnetic induction when an object-to-be-heated such as silicon wafer is heated, and a heating apparatus using the glass-like carbon induction heating element, and a heater having a glass-like carbon heating reactor tube or an induction heating vessel.

### BACKGROUND ART

An induction heating method, in which a high frequency induction coil is applied with a current to allow a heating element to inductively generate heat, thereby an object-to-be-heated is heated, is frequently used for applications requiring rapid temperature rise, uniform heating, and excellent temperature response (controllability) and the like, including heating treatment of a silicon wafer in a semiconductor integrated circuit manufacturing process. As typical characteristics required for such a heating element that inductively generates heat by electromagnetic induction, constant conductivity, chemical/physical stability even in a heat generation condition (heating condition), and a small thermal expansion coefficient are given. Furthermore, when the method is used for the heating treatment of the silicon wafer in the semiconductor integrated circuit manufacturing process, the heating element is required to be extremely low in production of impurities of metal and the like.

The conventional materials of the induction heating element are roughly classified into metal material and carbon material including graphite. Among them, the metal material had advantages of ease in machining and comparatively low cost, however, it may cause metal impurities, or is problematic in corrosion resistance, therefore the metal material is not suitable for the semiconductor integrated circuit manufacturing process. The carbon material including graphite is high in corrosion resistance compared with the metal material, and less problematic in production of metal impurities, however, the carbon material itself inevitably produces particles such as fine powder of carbon. Therefore, a heating element is often used, of which the surface is coated with silicon carbide (SiC), or glass-like carbon (or glassy carbon) (GLC). However, the heating element has been pointed out with a problem that such coating is separated, causing formation of particles, or a problem that particles are produced from the inside through defects in the coating.

On the other hand, glass-like carbon is a conductive material and usable for a material of the induction heating element, in addition, excellent in heat resistance, corrosion resistance, and gas impermeability, and low in dust production. Therefore, a glass-like carbon induction heating element has been known, which is used in the semiconductor integrated circuit manufacturing process (for example, JP-A-8-181150 and JP-A-2003-151737).

However, the usual glass-like carbon induction heating element has not necessarily provided a sufficient result in heating efficiency.

A glass-like carbon induction heating reactor tube or a glass-like carbon induction heating vessel, which is disposed in air atmosphere, and stores an object-to-be-heated in the inside, is limited in use temperature to comparatively low temperature since glass-like carbon does not have sufficient oxidation resistance, and may be consumed by oxidization when it is contacted to oxygen at high temperature. Furthermore, since the tube or vessel is large in heat radiation from an outer circumferential face, it does not have so high heating efficiency as expected. For improving the oxidation resistance, it is considered that oxidation resistant coating of silicon carbide or the like is applied to a surface of glass-like carbon. However, there is a problem that since the surface of glass-like carbon is chemically inactive, coating is easily separated. Moreover, while the glass-like carbon is inevitably subjected to temperature change since it is used for a heating apparatus, generally, glass-like carbon and a coating material are not equal in linear expansion coefficient, therefore a film may be separated due to stress caused by temperature change. In addition, extremely high cost is required for coating treatment.

[Patent document 1] JP-A-8-181150 (see page 3, FIG. 2)

[Patent document 2] JP-A-2003-151737 (see page 2, FIG. 1)

### DISCLOSURE OF THE INVENTION

Thus, a problem of the invention is to provide a glass-like carbon induction heating element having high heating efficiency, which is used for heating treatment of an object-to-be-heated such as silicon wafer by induction heating, and a heating apparatus. Another problem of the invention is to provide a heater in which the glass-like carbon induction heating reactor tube or glass-like carbon induction heating vessel, which is disposed in air atmosphere, and stores an object-to-be-heated in the inside, is designed to be excellent in oxidation resistance to air atmosphere, and able to be used in higher temperature.

To solve the above problems, the invention of the application takes the following technical measures.

An invention of a first aspect is a glass-like carbon induction heating element, which inductively generates heat by electromagnetic induction, characterized by having an infrared radiation characteristic that a ratio (E1/E2) of infrared radiation intensity (E1) of an opposed face to an object-to-be-heated to infrared radiation intensity (E2) of a non-opposed face to the object-to-be-heated exceeds 1.2.

An invention of a second aspect is a heating apparatus characterized by having the glass-like carbon induction heating element according to the first aspect, and a high frequency induction coil that is disposed outside the glass-like carbon induction heating element for allowing the glass-like carbon induction heating element to inductively generate heat, wherein the high frequency induction coil is applied with a current so that an object-to-be-heated is heated by infrared rays radiated from the glass-like carbon induction heating element.

An invention of a third aspect is the heating apparatus according to the second aspect characterized in that the heating apparatus has a reactor vessel inside which the glass-like carbon induction heating element is stored, and outside which the high frequency induction coil is disposed.

An invention of a fourth aspect is the heating apparatus according to the third aspect characterized in that the heating apparatus has a covering member made up of carbon fiber low-density molding that covers an outer circumferential face of the reactor vessel.

An invention of a fifth aspect is the heating apparatus according to any one of the second to fourth aspects characterized in that the glass-like carbon induction heating element is in a cylindrical shape inside which the object-to-be-heated is stored.

An invention of a sixth aspect is the heating apparatus according to the third aspect characterized in that the glass-like carbon induction heating element is in a flat plate shape near which the object-to-be-heated is disposed.

An invention of a seventh aspect is a heater characterized by having a glass-like carbon induction heating reactor tube that is made up of glass-like carbon, and stores an object-to-be-heated in the inside; a high frequency induction coil that is disposed outside the glass-like carbon induction heating reactor tube for allowing the glass-like carbon induction heating reactor tube to inductively generate heat; and a covering member made up of carbon fiber low-density molding that covers a portion facing the high frequency induction coil in an outer circumferential face of the glass-like carbon induction heating reactor tube.

An invention of an eighth aspect is a heater characterized by having a glass-like carbon induction heating vessel that is made up of glass-like carbon, and stores an object-to-be-heated in the inside; a high frequency induction coil that is disposed outside the glass-like carbon induction heating vessel for allowing the glass-like carbon induction heating reactor tube to inductively generate heat; and a covering member made up of carbon fiber low-density molding that covers a portion facing the high frequency induction coil in an outer circumferential face of the glass-like carbon induction heating vessel.

### EFFECTS OF THE INVENTION

The glass-like carbon induction heating element of the invention of the application is formed such that the heating element has the infrared radiation characteristic that the ratio (E1/E2) of the infrared radiation intensity (E1) of the opposed face to the object-to-be-heated to the infrared radiation intensity (E2) of the non-opposed face to the object-to-be-heated exceeds 1.2. Thus, the heating element is used as an induction heating element for a heating apparatus, thereby temperature increase of the glass-like carbon induction heating element itself, and radiation of infrared rays to the object-to-be-heated by the opposed face to the object-to-be-heated of the induction heating element 11, which corresponds to heat radiation from the induction heating element, can be performed in a well-balanced manner, consequently high heating efficiency can be obtained compared with a heating element, which does not have such an infrared radiation characteristic ((E1/E2)>1.2), even at the same input power.

Moreover, according to the heating apparatus of the invention of the application, since the apparatus has the glass-like carbon induction heating element endowed with the infrared radiation characteristic, and the high frequency induction coil is applied with a current so that the object-to-be-heated is heated by infrared rays radiated from the glass-like carbon induction heating element, excellent heating efficiency can be exhibited.

The heater of the invention of the application is configured such that a glass-like carbon induction heating reactor tube or a glass-like carbon induction heating vessel, inside which an object-to-be-heated is stored, is covered with a covering member made up of carbon fiber low-density molding at a portion facing the high frequency induction coil in an outer circumferential face of the tube or vessel, that is, a portion to be at high temperature in the outer circumferential face. Since the covering member made up of the carbon fiber low-density molding prevents oxygen in air atmosphere from being diffused to neighborhood of the portion to be at high temperature by induction heating in the outer circumferential face, in addition, carbon fiber itself reacts with hydrogen, oxygen concentration can be decreased in the portion to be at high temperature by induction heat generation in the outer circumferential face, thereby the glass-like carbon induction heating reactor tube itself or the glass-like carbon induction heating vessel itself can be effectively prevented from being consumed by oxidation. Moreover, since the covering member made up of the carbon fiber low-density molding has extremely small heat conductivity compared with glass-like carbon, heat radiation from the portion to be at high temperature by induction heat generation in the outer circumferential face of the glass-like carbon induction heating reactor tube or the glass-like carbon induction heating vessel can be effectively prevented. Moreover, the covering member made up of carbon fiber low-density molding can be easily exchanged as needed.

Consequently, in the heater of the invention of the application, the glass-like carbon induction heating reactor tube or the glass-like carbon induction heating vessel, which is disposed in air atmosphere, and has the object-to-be-heated stored in the inside, is covered with the covering member made up of carbon fiber low-density molding at the portion facing the high frequency induction coil in the outer circumferential face of the tube or vessel, thereby even if the outer circumferential face is exposed to the air, the tube or vessel is able to have oxidation resistance to air atmosphere at low cost compared with a tube or vessel applied with oxidation resistant coating of silicon carbide or the like on an outer circumferential face, and have heat-radiation protection performance, and consequently is can be used at higher temperature.

### BRIEF DESCRIPTION OF THE DRAWINGS

FIG. 1 is a cross section diagram schematically showing a configuration of a heating apparatus according to an embodiment of the invention.

FIG. 2 is a cross section diagram schematically showing a configuration of a heating apparatus according to another embodiment of the invention.

FIG. 3 is a cross section diagram schematically showing a configuration of a heating apparatus according to still another embodiment of the invention.

FIG. 4 is a cross section diagram schematically showing a configuration of a heater according to an embodiment of the invention.

FIG. 5 is a cross section diagram schematically showing a configuration of a heater according to another embodiment of the invention.

### REFERENCE NUMERALS AND SIGNS

10, 10′ heating apparatus
11 glass-like carbon induction heating element
12 high frequency induction coil
13 reactor vessel
14 covering member
20 heating apparatus
21 glass-like carbon induction heating element
22 high frequency induction coil
23 reactor vessel
30, 40 heater
31, 41 glass-like carbon induction heating reactor tube
32, 42 high frequency induction coil
33, 43 covering member
34, 44 rubber plug
35 gas inlet tube
36 gas outlet tube

### BEST MODE FOR CARRYING OUT THE INVENTION

A glass-like carbon induction heating element of the invention and a heating apparatus using the heating element are described.

It has been considered that heating efficiency in the induction heating method is achieved by optimization of apparatus parameters such as power of a high frequency magnetic field given to an induction heating element, arrangement of a high frequency induction coil, and a distance between the high frequency induction coil and the induction heating element. However, the inventor made various studies on factors affecting heating efficiency, as a result, found that not only the apparatus parameters, but also infrared emissivity (infrared radiation intensity) of the glass-like carbon heating element itself has a significant effect on the heating efficiency, and consequently the inventor made the invention.

That is, carbon materials are typically known as materials having high infrared emissivity (infrared radiation intensity), however, according to the inventor, it was found that a glass-like carbon member had a low infrared emissivity, 40% or less, in some surface roughness condition, in addition, significantly varied depending on a surface roughness condition. Due to this property, even if the glass-like carbon member is applied with a high frequency magnetic field so as to be heated to a certain temperature, the amount of heat radiation from the glass-like carbon member highly depends on infrared emissivity (infrared radiation intensity).

In the glass-like carbon induction heating element of the invention, surface roughness of an opposed face to an object-to-be-heated and surface roughness of a non-opposed face to the object-to-be-heated are adjusted, thereby infrared radiation intensity (E1) of the opposed face to the object-to-be-heated is increased so as to be more than 1.2 times larger than infrared radiation intensity (E2) of the non-opposed face to the object-to-be-heated, and thereby heating efficiency is extremely improved. That is, in the glass-like carbon induction heating element of the invention, surface roughness is adjusted, thereby infrared rays are, in a manner, selectively radiated to the object-to-be-heated, and thereby temperature increase of the glass-like carbon induction heating element itself, and radiation of infrared rays to the object-to-be-heated by the opposed face to the object-to-be-heated of the induction heating element, which corresponds to heat radiation from the induction heating element, can be performed in a well-balanced manner, consequently high heating efficiency can be obtained compared with a heating element that does not have such an infrared radiation characteristic ((E1/E2)>1.2) obtained by such adjustment of surface roughness even at the same input power.

In the glass-like carbon induction heating element of the invention, infrared emissivity (infrared radiation intensity) of each of the opposed face and the non-opposed face to the object-to-be-heated can be adjusted by adjusting surface roughness as described before. In a glass-like carbon induction heating element, while surface roughness depends on a kind of material, formation method, baking method, and surface treatment method, generally, as a surface is smoother, infrared emissivity (infrared radiation intensity) is smaller, and as a surface is rougher, infrared emissivity (infrared radiation intensity) is larger. Thus, when the glass-like carbon induction heating element is in a shape of flat plate on which the object-to-be-heated is placed, the opposed face to the object-to-be-heated (surface) is made to be rough, and a face (back) at a side opposite to the surface is made to be smooth. When the glass-like carbon induction heating element is in a shape of cylinder inside which the object-to-be-heated is stored, an inner circumferential face being opposed to the object-to-be-heated is made to be rough, and an outer circumferential face being not opposed to the object-to-be-heated is made to be smooth. In this case, while infrared emissivity (infrared radiation intensity) may somewhat vary depending on the number of defects or bubbles within the heating element, typically, a ratio of surface roughness of the opposed face to that of the non-opposed face is made two times or more, preferably five times or more, thereby a ratio of the infrared radiation intensity (E1) of the opposed face to the infrared radiation intensity (E2) of the non-opposed face can be made to be more than 1.2.

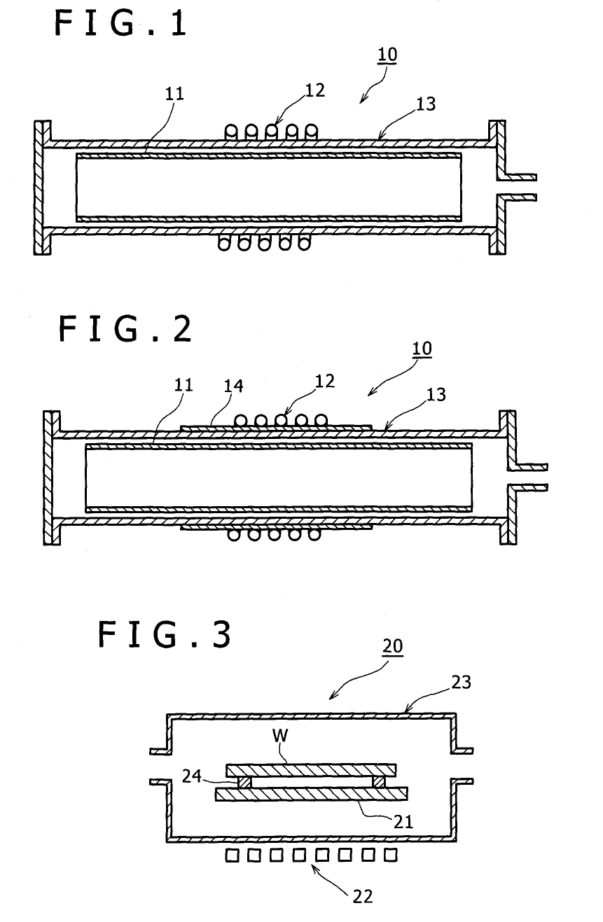

FIG. 1 is a cross section diagram schematically showing a configuration of a heating apparatus according to an embodiment of the invention.

As shown in FIG. 1, the heating apparatus 10 is in a cylindrical shape, and has a glass-like carbon induction heating element 11 inside which an object-to-be-heated (not shown) such as silicon wafer is stored; a quartz reactor vessel 13 that has a cylindrical barrel, inside which a cylindrical space is formed, for storing the glass-like carbon induction heating element 11; a high frequency induction coil 12 being wound on an outer circumferential face of the cylindrical barrel of the reactor vessel 13 for allowing the glass-like carbon induction heating element 11 to inductively generate heat; and a high frequency power supply (not shown) for supplying high frequency AC power to the high frequency induction coil 12; wherein the high frequency induction coil 12 is applied with a current to allow the glass-like carbon induction heating element 11 to inductively generate heat, thereby the object-to-be-heated is subjected to heating treatment by infrared rays radiated from the glass-like carbon induction heating element 11. The glass-like carbon induction heating element 11 and the high frequency induction coil 12 are disposed concentrically with each other.

In the glass-like carbon induction heating element 11 of the heating apparatus 10, an inner circumferential face forms an opposed face being opposed to the object-to-be-heated, and an outer circumferential face forms a non-opposed face being not opposed to the object-to-be-heated, and surface roughness of each of the inner and outer circumferential faces is adjusted, thereby the heating element has an infrared radiation characteristic that a ratio (E1/E2) of infrared radiation intensity (E1) of the inner circumferential face (opposed face to the object-to-be-heated) to infrared radiation intensity (E2) of the outer circumferential face (non-opposed face to the object-to-be-heated) exceeds 1.2.

According to the heating apparatus 10 configured in this way, temperature increase of the glass-like carbon induction heating element 11 itself, and radiation of infrared rays to the object-to-be-heated by the inner circumferential face of the induction heating element 11, which corresponds to heat radiation from the induction heating element 11, can be performed in a well-balanced manner, thereby the object-to-be-heated can be heated in a shorter time even at the same input power, and consequently high heating efficiency can be obtained compared with a heating element that does not have the infrared radiation characteristic ((E1/E2)>1.2).

FIG. 2 is a cross section diagram schematically showing a configuration of a heating apparatus according to another embodiment of the invention. Note that since the heating apparatus is in the same configuration as that of the heating apparatus 10 shown in FIG. 1 except that a covering member 14 is added, portions common to those of the heating apparatus 10 are marked with like references and the description thereof are omitted and only different points will be described.

[The to-be-Heated Object]

As shown in FIG. 2, the heating apparatus 10′ has the covering member 14, for example, carbon fiber felt, which is made up of carbon fiber low-density molding, and covers an outer circumferential face of the reactor vessel 13. Thus, according to the heating apparatus 10′, temperature increase of the glass-like carbon induction heating element 11 itself, and radiation of infrared rays to the object-to-be-heated by the inner circumferential face of the induction heating element 11, which corresponds to heat radiation from the induction heating element 11, can be performed in a well-balanced manner, and furthermore, heat radiation from a surface of the reactor vessel is prevented by the covering member 14, consequently high heating efficiency can be obtained compared with a heating element that does not have the covering member 14.

FIG. 3 is a cross section diagram schematically showing a configuration of a heating apparatus according to still another embodiment of the invention.

As shown in FIG. 3, the heating apparatus 20 is in a flat plate shape, and has a glass-like carbon induction heating element 21 on which an object-to-be-heated W such as silicon wafer is placed via a spacer 24; a quartz reactor vessel 23 that has a space in a rectangular solid shape inside the vessel to store the glass-like carbon induction heating element 21; a spiral, high frequency induction coil 22, which is disposed below the glass-like carbon induction heating element 21 and outside the reactor vessel 23, to allow the glass-like carbon induction heating element 21 to inductively generate heat; and a high frequency power supply (not shown) for supplying high frequency AC power to the high frequency induction coil 22; wherein the high frequency induction coil 22 is applied with a current so that the glass-like carbon induction heating element 21 is inductively generates heat, thereby the object-to-be-heated W is subjected to heating treatment by infrared rays radiated from the glass-like carbon induction heating element 21.

In the glass-like carbon induction heating element 21 of the heating apparatus 20, a surface forms an opposed face being opposed to the object-to-be-heated W, and a back forms a non-opposed face being not opposed to the object-to-be-heated W, and surface roughness of each of the surface and the back is adjusted, thereby the heating element has an infrared radiation characteristic that a ratio (E1/E2) of infrared radiation intensity (E1) of the surface (opposed face to the object-to-be-heated) to infrared radiation intensity (E2) of the back (non-opposed face to the object-to-be-heated) exceeds 1.2.

According to the heating apparatus 20 configured in this way, temperature increase of the glass-like carbon induction heating element 21 itself, and radiation of infrared rays to the object-to-be-heated W by the surface of the induction heating element 21, which corresponds to heat radiation from the induction heating element 21, can be performed in a well-balanced manner, thereby the object-to-be-heated W can be heated in a shorter time even at the same input power, and consequently high heating efficiency can be obtained compared with a heating element that does not have the infrared radiation characteristic ((E1/E2)>1.2).

### EXAMPLE 1

Next, examples of the glass-like carbon induction heating element of the invention, and the heating apparatus using the heating element are described.

First, description is made on measurement of infrared emissivity as infrared radiation intensity of each of the opposed and non-opposed faces to the object-to-be-heated of the glass-like carbon induction heating element. For the measurement of infrared emissivity, Fourier transform infrared spectrophotometer JIR-5500 and infrared radiation measurement unit IRR-200 manufactured by JEOL Ltd. was used as an apparatus, and a substrate 3 cm square was used as a specimen (when a heating element itself is not mounted in the apparatus, it is appropriately cut out). As a method of measuring infrared emissivity, spectral radiant intensity (measurement values) of two points (160° C. and 80° C.) in a black-body furnace and the intensity of the specimen were measured, then the intensity and spectral radiant intensity of the black-body (theoretical value) were used to obtain spectral radiant intensity of the specimen, and then integrated emissivity was calculated from such an obtained value of the spectral radiant intensity, and the integrated emissivity was assumed as infrared emissivity. A measurement condition was set as follows: resolution was 16 cm⁻¹, measurement temperature (temperature of a specimen heating stage) was 200° C., and a wavelength range was 4.5 to 15.4 μm. The measurement of infrared emissivity was performed for optional, three points in effective heating area of a glass-like carbon induction heating element as a measurement object, and an average value of infrared emissivity values at the three points was used.

First, for a material resin of glass-like carbon, a commercially available, liquid phenol resin, PL4804 manufactured by Gun-Ei Chemical Industry Co., Ltd. was subjected to heat treatment for 1 hour at 100° C. under reduced pressure to be adjusted in moisture percentage, and then used as the material resin of glass-like carbon.

Next, for molding of a phenol resin cylindrical body, a centrifugal molding machine was used, which has a cylindrical centrifugal molding die made of stainless steel 60 mm in inner diameter and 600 mm in length. As the cylindrical centrifugal molding die, plural dies having different kinds of surface roughness were prepared so that surface roughness of an outer circumferential face of a glass-like carbon cylindrical body was able to be changed. Then, the liquid material resin of 520 g was charged in the centrifugal molding die, and then the material resin was cured by holding the resin for 24 hours at a die surface temperature of 80° C. while the centrifugal molding die was rotated at a speed of 600 revolutions per minute, so that the phenol resin cylindrical body was obtained. Next, the phenol resin cylindrical body was heated for 50 hours at 250° C. and thus perfectly cured, and then the cylindrical body was further subjected to heat treatment for 5 hours at 1000° C. in nitrogen atmosphere to be carbonized, thereby a glass-like carbon cylindrical body 48 mm in outer diameter, 3.2 mm in thickness, and 480 mm in length was obtained.

As the glass-like carbon cylindrical body, plural glass-like carbon cylindrical bodies were prepared, and inner circumferential faces of respective bodies were polished using sandpapers having different counts to adjust surface roughness (arithmetic mean surface roughness Ra), thereby four glass-like carbon induction heating elements of examples 1-1 to 1-4 were obtained as the glass-like carbon induction heating element 11 of the heating apparatus 10 as shown in FIG. 1. Moreover, glass-like carbon induction heating elements of comparative examples 1 to 3 were prepared. The high frequency induction coil 12 was formed by spirally winding a water-cooled copper tube 6 mm in outer diameter 5 times with inner diameter of 70 mm and a coil pitch of 10 mm.

In a heating test, the inside of the reactor vessel 13 was kept at nitrogen gas atmosphere, and the high frequency induction coil 12 was supplied with high frequency power at a condition of frequency of 430 kHz, output power of 1.2 kW, and a current of 6 A, and measurement was made on time taken before temperature (measured using a thermocouple) of a central portion of the inside of the glass-like carbon induction heating element reached 600° C. Here, it is supposed that the object-to-be-heated is disposed inside the glass-like carbon induction heating element. Table 1 shows a method of adjusting surface roughness, surface roughness (arithmetic mean surface roughness Ra) and infrared emissivity of each of the outer and inner circumferential faces of the glass-like carbon induction heating element, and a result of the heating test.

TABLE 1

| | Cylindrical glass-like carbon induction heating element | | | | | | | |
|---|---|---|---|---|---|---|---|---|
| | | | | | Infrared emissivity | | | |
| | Outer circumferential | | Inner circumferential | | | | Ratio (inner | Time |
| | face of heating element | | face of heating element | | Outer | Inner | circumferential | before |
| | Finishing | Surface | | Surface | circumferential | circumferential | face/outer | reaching |
| | level of inner | roughness | Sandpaper | roughness | face of heating | face of heating | circumferential | 600° C. |
| Category | face of die | (μm) | treatment | (μm) | element | element | face) | (sec) |
| Comparative | Moderate | 0.2 | Not | 0.1 | 41.0 | 39.0 | 0.95 | 52 |
| example 1 | | | performed | | | | | |
| Example 1-1 | Moderate | 0.2 | #400 | 0.8 | 41.0 | 51.0 | 1.24 | 16 |
| Example 1-2 | Moderate | 0.2 | #240 | 1.1 | 41.0 | 58.0 | 1.41 | 13 |
| Example 1-3 | Polished | 0.1 | #240 | 1.1 | 39.0 | 59.0 | 1.51 | 11 |
| Example 1-4 | Polished | 0.1 | #80 | 3.2 | 39.0 | 68.0 | 1.74 | 8 |
| Comparative | Blast #80 | 2.8 | #400 | 1.1 | 58.0 | 61.0 | 1.05 | 46 |
| example 2 | | | | | | | | |
| Comparative | Blast #80 | 2.8 | #80 | 3.2 | 59.0 | 67.0 | 1.14 | 39 |
| example 3 | | | | | | | | |

In the comparative example 1, the outer circumferential face of the glass-like carbon induction heating element was finished to have a surface roughness in using a centrifugal molding die having a moderately finished inner face, and the inner circumferential face was finished to have a surface roughness originated from the liquid resin without polishing with sandpaper. In the glass-like carbon induction heating element, a ratio (E1/E2) of infrared radiation intensity (E1) of the inner circumferential face being opposed to an object-to-be-heated to infrared radiation intensity (E2) of the outer circumferential face being not opposed to the object-to-be-heated was 0.95 which was out of specification of the invention, and 52 sec was taken before temperature (≅temperature of the object-to-be-heated) of a central portion of the inside of the glass-like carbon induction heating element reached 600° C.

In the example 1-1, the outer circumferential face of the glass-like carbon induction heating element was finished to have the surface roughness in using the centrifugal molding die having the moderately finished inner face, and the inner circumferential face was finished to have a surface roughness of a surface roughed by using #400 sandpaper. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.24, and time taken before reaching 600° C. was 16 sec.

In the example 1-2, the outer circumferential face of the glass-like carbon induction heating element was finished to have the surface roughness in using the centrifugal molding die having the moderately finished inner face (as in the example 1-1), and the inner circumferential face was finished to have a surface roughness of a surface obtained by #240 sandpaper treatment. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.41, and the time taken before reaching 600° C. was 13 sec.

In the example 1-3, the outer circumferential face of the glass-like carbon induction heating element was finished to have a surface roughness in using a centrifugal molding die having a polished inner face, and the inner circumferential face was finished to have the surface roughness of the surface obtained by #240 sandpaper treatment as in the example 1-2. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.51, and the time taken before reaching 600° C. was 11 sec.

In the example 1-4, the outer circumferential face of the glass-like carbon induction heating element was finished to have the surface roughness in using the centrifugal molding die having the polished inner face (as in the example 1-3), and the inner circumferential face was finished to have a surface roughness of a surface obtained by #80 sandpaper treatment. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.74, and the time taken before reaching 600° C. was 8 sec.

In the comparative example 2, the outer circumferential face of the glass-like carbon induction heating element was finished to have a surface roughness in using a centrifugal molding die having an inner face subjected to #80 blast treatment, and the inner circumferential face was finished to have a surface roughness of a surface obtained by #400 sandpaper treatment. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.05 which was out of the specification of the invention, and the time taken before reaching 600° C. was 46 sec.

In the comparative example 3, the outer circumferential face of the glass-like carbon induction heating element was finished to have a surface roughness in using the centrifugal molding die having the inner face subjected to the #80 blast treatment, and the inner circumferential face was finished to have the surface roughness of the surface obtained by #80 sandpaper treatment. In the glass-like carbon induction heating element, the ratio (E1/E2) of the infrared radiation intensity (E1) of the inner circumferential face being opposed to the object-to-be-heated to the infrared radiation intensity (E2) of the outer circumferential face being not opposed to the object-to-be-heated was 1.14 which was out of the specification of the invention, and the time taken before reaching 600° C. was 39 sec.

In this way, in the examples 1-1 to 1-4, the temperature was able to reach 600° C. in a short time compared with in the comparative example 1 to 3 even at the same input power, consequently high heating efficiency was obtained. Heating speed of the glass-like carbon induction heating element itself is considered to be determined by input power and heat radiation (exhaust heat) speed. Here, if the glass-like carbon induction heating elements themselves are equal (constant) in temperature, the object-to-be-heated is more rapidly heated with a glass-like carbon induction heating element having higher infrared emissivity of the opposed face to the object-to-be-heated (an effect of the infrared emissivity of the opposed face). On the other hand, when a heating process of the glass-like carbon induction heating element itself is considered, radiation to the outside (a side where the object-to-be-heated is not present) corresponds to heat dissipation, and the glass-like carbon induction heating element itself is more rapidly heated with smaller infrared emissivity of the non-opposed face to the object-to-be-heated (an effect of the infrared emissivity of the non-opposed face). It is considered that difference in time before reaching the temperature of 600° C. between the examples 1-1 to 1-4 and the comparative examples 1 to 3 is caused by the effects of infrared emissivity (infrared radiation intensity) of the inner and outer circumferential faces due to two factors as above.

### EXAMPLE 2

In the heating apparatus 10′ as shown in FIG. 2, the same glass-like carbon induction heating element as in the example 1-1 was used as the glass-like carbon induction heating element 11, and carbon fiber felt (“KRECA FR” manufactured by Kureha Corporation) 3 mm in thickness was wound on an outer circumferential face of the reactor vessel 13 as the covering member 14. Then, a heating test was performed at the same condition as in the example 1. As a result, 12 sec was taken as time before temperature of a central portion of the inside of the glass-like carbon induction heating element reached 600° C. In addition, heat radiation from a surface of the reactor vessel 13 was prevented, consequently high heating efficiency was able to be obtained compared with that in the example 101 in which the covering member 14 was not provided.

Next, a heater of the invention is described.

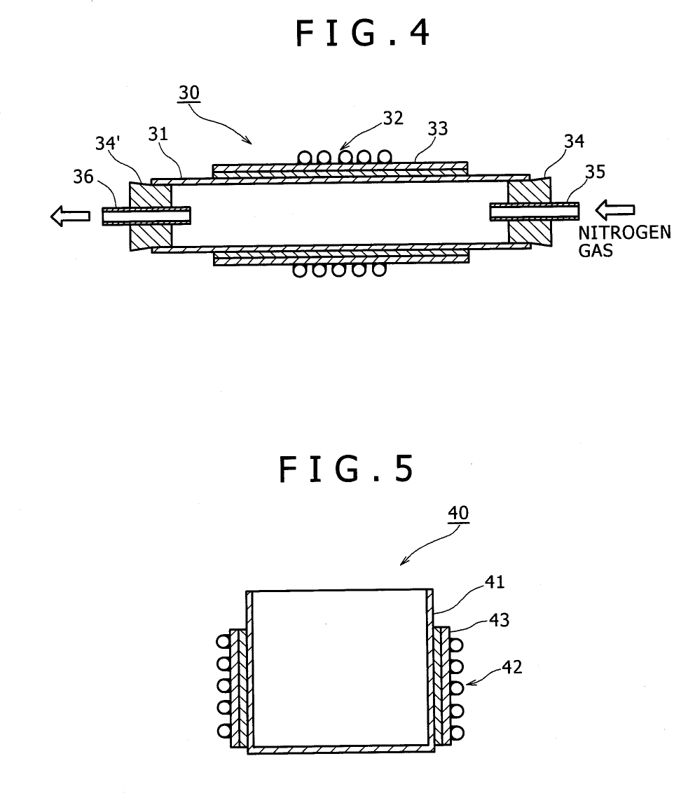

FIG. 4 is a cross section diagram schematically showing a configuration of a heater according to an embodiment of the invention.

As shown in FIG. 4, the heater 30 has a cylindrical, glass-like carbon induction heating reactor tube 31 that is made up of glass-like carbon and disposed in air atmosphere, inside which inert gas atmosphere is kept, and an object-to-be-heated is stored; a high frequency induction coil 32, which is disposed outside the glass-like carbon induction heating reactor tube 31 and concentrically with the tube, for allowing the glass-like carbon induction heating reactor tube 31 to inductively generate heat; and a covering member 33 that covers a portion facing the high frequency induction coil 32 in an outer circumferential face of the glass-like carbon induction heating reactor tube 31, and is made up of carbon fiber low-density molding; wherein the high frequency induction coil 32 is applied with a current to allow the glass-like carbon induction heating reactor tube 31 to inductively generate heat, and the object-to-be-heated is subjected to heating treatment by infrared rays radiated from the glass-like carbon induction heating reactor tube 31. The high frequency induction coil 32 is connected to a high frequency power supply to be supplied with AC high frequency power. At one end of the glass-like carbon induction heating reactor tube 31, a rubber plug 34 is equipped, which is attached with a gas inlet tube 35 for introducing nitrogen gas into the glass-like carbon induction heating reactor tube 31. At the other end of the glass-like carbon induction heating reactor tube 31, a rubber plug 34′ attached with a gas outlet tube 36 is equipped.

According to the heater 30 configured in this way, in the glass-like carbon induction heating reactor tube 31, which is disposed in air atmosphere and stores the object-to-be-heated in the inside being kept at inert gas atmosphere, the portion facing the high frequency induction coil 32 in the outer circumferential face of the tube, that is, a portion to be at high temperature in the outer circumferential face is covered with the covering member 33 made up of the carbon fiber low-density molding, thereby the reactor tube 31 is able to have oxidation resistance to air atmosphere at low cost compared with a tube applied with oxidation resistant coating of silicon carbide or the like on an outer circumferential face, and have heat radiation protection performance, and consequently the reactor tube can be used at higher temperature.

In this case, the covering member 33 is made up of a commercially available, known carbon fiber low-density molding, including a carbon fiber fabric, carbon fiber woven, or lamination of them, or a three-dimensional molding of carbon fiber. The covering member 33 made up of the carbon fiber low-density molding preferably has a thickness of more than 1 mm, more preferably 3 mm or more in a condition of covering the outer circumferential face of the glass-like carbon induction heat generation reactor tube 31 in order to obtain an oxidation prevention effect and a heat radiation prevention effect.

FIG. 5 is a cross section diagram schematically showing a configuration of a heater according to another embodiment of the invention.

As shown in FIG. 5, the heater 40 has a cup-like, glass-like carbon induction heating vessel 41 that is made up of glass-like carbon and disposed in air atmosphere, inside which inert gas atmosphere is kept, and an object-to-be-heated is stored; a high frequency induction coil 42 that is disposed outside the glass-like carbon induction heating vessel 41 and concentrically with the vessel 41 for allowing the glass-like carbon induction heating vessel 41 to inductively generate heat; and a covering member 43 that is made up of carbon fiber low-density molding such as carbon fiber felt for covering a portion facing the high frequency induction coil 42 in the outer circumferential face of the glass-like carbon induction heating vessel 41; wherein the high frequency induction coil 42 is applied with a current to allow the glass-like carbon induction heating vessel 41 to inductively generate heat, and the object-to-be-heated is subjected to heating treatment by infrared rays radiated from the glass-like carbon induction heating vessel 41.

According to the heater 40 configured in this way, in the glass-like carbon induction heating vessel 41, which is disposed in air atmosphere and stores the object-to-be-heated in the inside being kept at the inert gas atmosphere, the portion facing the high frequency induction coil 42 in the outer circumferential face of the vessel, that is, a portion to be at high temperature in the outer circumferential face is covered with the covering member 43 made up of the carbon fiber low-density molding, thereby the heating vessel 41 is able to have oxidation resistance to air atmosphere at low cost compared with a vessel applied with oxidation resistant coating of silicon carbide or the like on an outer circumferential face, and have heat radiation protection performance, and consequently the vessel can be used at higher temperature.

### EXAMPLE 3

Next, an example of the heater of the invention is described below.

First, for a material resin of glass-like carbon, a commercially available, liquid phenol resin, PL4804 manufactured by Gun-Ei Chemical Industry Co., Ltd. was subjected to heat treatment for 1 hour at 100° C. under reduced pressure to be adjusted in moisture percentage, and then used as the material resin of glass-like carbon.

Next, for molding of a phenol resin cylindrical body, a centrifugal molding machine was used, which has a cylindrical centrifugal molding die made of stainless steel 60 mm in inner diameter and 600 mm in length. The liquid material resin of 520 g was charged in the centrifugal molding die, then the material resin was cured by holding the resin for 24 hours at a die surface temperature of 80° C. while the centrifugal molding die was rotated at a speed of 600 revolutions per minute, and consequently the phenol resin cylindrical body was obtained.

Next, the phenol resin cylindrical body was heated for 50 hours at 250° C. and thus perfectly cured, and then the cylindrical body was further subjected to heat treatment for 5 hours at 1000° C. in nitrogen atmosphere to be carbonized, thereby a glass-like carbon induction heating reactor tube (48 mm in outer diameter, 3.2 mm in thickness, and 480 mm in length) for examples 3-1 and 3-2 was obtained as the glass-like carbon induction heating reactor tube 31 of the heater 30 as shown in FIG. 4. Moreover, a glass-like carbon induction heating reactor tube for comparative examples 4 and 5 was produced in the same way. The high frequency induction coil 32 was formed by spirally winding a water-cooled copper tube 6 mm in outer diameter 5 times with inner diameter of 70 mm and a coil pitch of 10 mm.

In a heating test, the inside of the glass-like carbon induction heating reactor tube was kept at nitrogen gas atmosphere, and the high frequency induction coil 32 was held for 1 hour while being supplied with high frequency power at a condition of frequency of 430 kHz, output power of 1.2 kW, and a current of 6 A. At that time, temperature of a central portion of the inside of the glass-like carbon induction heating reactor tube was measured using a thermocouple, and the glass-like carbon induction heating reactor tube was measured in weight before and after heating in order to know a consumption level by oxidation of the tube. A result of the heating test is shown in Table 2.

TABLE 2

| | | Thickness | | Rate of |
|---|---|---|---|---|
| | | of covering | Maximum | weight |
| Category | Covering member | member | temperature | reduction |
| Comparative | Not provided | — | 550° C. | 8% |
| example 4 | | | | |
| Example 3-1 | Carbon fiber felt | 6 mm | 750° C. | 0.3% |
| | Double winding | in total | | |
| Comparative | Carbon fiber | 1 mm | 630° C. | 4% |
| example 5 | handwoven cloth | | | |
| | Single winding | | | |
| Example 3-2 | Carbon fiber | 10 mm | 700° C. | 0.5% |
| | handwoven cloth | in total | | |
| | Tenfold winding | | | |

In the comparative example 4, the heating test was performed without providing the covering member 33. The temperature of the central portion of the inside of the glass-like carbon induction heating reactor tube reached 550° C. as its maximum. On the other hand, a rate of weight reduction of the glass-like carbon induction heating reactor tube was 8%.

In the example 3-1, a commercially available, carbon fiber felt (trade name “KRECA FR” manufactured by Kureha Chemical Industry Co., Ltd.) 3 mm in thickness was used as the covering member 33, and doubly wound on the outer circumferential face of the glass-like carbon induction heating reactor tube. The temperature of the central portion of the inside of the glass-like carbon induction heating reactor tube reached 750° C. as its maximum. On the other hand, the rate of weight reduction of the glass-like carbon induction heating reactor tube was slight, 0.3%.

In the comparative example 5, carbon fiber handwoven cloth 1 mm in thickness was singly wound on the outer circumferential face of the glass-like carbon induction heating reactor tube as the covering member 33. The temperature of the central portion of the inside of the glass-like carbon induction heating reactor tube reached 630° C. as its maximum. However, the carbon fiber handwoven cloth was drastically consumed, so that the rate of weight reduction of the glass-like carbon induction heating reactor tube was 4%, and consequently both oxidation resistance and heat radiation prevention performance were insufficient.

In the example 3-2, carbon fiber handwoven cloth 1 mm in thickness was tenfold wound on the outer circumferential face of the glass-like carbon induction heating reactor tube as the covering member 33 (10 mm in total thickness). The temperature of the central portion of the inside of the glass-like carbon induction heating reactor tube reached 700 as its maximum, and the rate of weight reduction of the glass-like carbon induction heating reactor tube was 0.5%, consequently both oxidation resistance and heat radiation prevention performance were sufficiently excellent.

1. A glass-like carbon induction heating element that inductively generates heat by electromagnetic induction, comprising:
an infrared radiation characteristic that a ratio (E1/E2) of infrared radiation intensity (E1) of an opposed face to an object-to-be-heated to infrared radiation intensity (E2) of a non-opposed face to the object-to-be-heated exceeds 1.2.

2. A heating apparatus, comprising:
the glass-like carbon induction heating element according to claim 1, and
a high frequency induction coil that is disposed outside the glass-like carbon induction heating element for allowing the glass-like carbon induction heating element to inductively generate heat,
wherein the high frequency induction coil is applied with a current so that an object-to-be-heated is heated by infrared rays radiated from the glass-like carbon induction heating element.

3. The heating apparatus according to claim 2, further comprising:
a reactor vessel inside which the glass-like carbon induction heating element is stored, and outside which the high frequency induction coil is disposed.

4. The heating apparatus according to claim 3, further comprising:
a covering member made up of carbon fiber low-density molding that covers an outer circumferential face of the reactor vessel.

5. The heating apparatus according to claim 4, wherein:
the glass-like carbon induction heating element is in a cylindrical shape inside which the object-to-be-heated is stored.

6. The heating apparatus according to claim 3, wherein:
the glass-like carbon induction heating element is in a flat plate shape near which the object-to-be-heated is disposed.

7. A heater, comprising:
a glass-like carbon induction heating reactor tube that is made up of glass-like carbon, and stores an object-to-be-heated in the inside,
a high frequency induction coil that is disposed outside the glass-like carbon induction heating reactor tube for allowing the glass-like carbon induction heating reactor tube to inductively generate heat, and
a covering member made up of carbon fiber low-density molding that covers a portion facing the high frequency induction coil in an outer circumferential face of the glass-like carbon induction heating reactor tube.

8. A heater, comprising:
a glass-like carbon induction heating vessel that is made up of glass-like carbon, and stores an object-to-be-heated in the inside,
a high frequency induction coil that is disposed outside the glass-like carbon induction heating vessel for allowing the glass-like carbon induction heating reactor tube to inductively generate heat, and
a covering member made up of carbon fiber low-density molding covering a portion facing the high frequency induction coil in an outer circumferential face of the glass-like carbon induction heating vessel.
